(19) United States
(12) Patent Application Publication
(10) Pub. No.: US 2010/0150356 A1
(43) Pub. Date: Jun. 17, 2010

(54) Body-worn hearing aid system

(76) Inventors: Michael Uzuanis, Willowbrook, IL (US); Richard Uzuanis, Burr Ridge, IL (US)

Correspondence Address: Carmen Patti Law Group , LLC, ONE N. LASALLE STREET, 44TH FLOOR, CHICAGO, IL, 60602, US

(21) Appl. No.: 12/658,901

(22) Filed: Feb. 16, 2010

Related U.S. Application Data
(63) Continuation-in-part of application No. 12/270,385, filed on Nov. 13, 2008.

(51) Int. Cl. H04R 25/00; H04R 5/00; H04R 29/00

(52) U.S. Cl. 381/23.1; 381/323; 381/60

(57) ABSTRACT

A binaural hearing aid system for a user is set forth. The system includes a casing adapted and constructed to encase a hearing aid system suitable for wearing below the neck of the user. A first digital signal processor, having an audio input from a first microphone of the hearing system, is also provided. The first digital signal processor produces a first audio output corresponding to a first hearing profile. A second digital signal processor having the audio input from the second microphone of the hearing system is also provided. The second digital signal processor produces a second audio output corresponding to a second hearing profile.

### CROSS REFERENCE TO RELATED APPLICATION

This application is a continuation-in-part of U.S. patent application Ser. No. 12/270,385, entitled “PERSONAL LISTENING DEVICE WITH AUTOMATIC SOUND EQUALIZATION AND HEARING TEST” incorporated herein by reference.

### TECHNICAL FIELD

This invention relates generally to a body-worn hearing aid device, and more particularly to a body-worn hearing aid device to be worn below the neck of a user having first and second audio outputs delivered via a headset, and wherein the device is selectively coupled to a magnetic coupling charging element.

### BACKGROUND

Numerous improvements to auditory prosthesis devices, or hearing aids, have developed in the last twenty years. Whereas hearing aids were once cumbersome and large, improvements in hearing aid technology have permitted the miniaturization of hearing aids. Many hearing aid wearers welcome the small and less obtrusive hearing aid devices. However, the miniaturization of hearing aids has not been advantageous for all populations.

Elderly persons and persons needing help with their daily care are challenged by the miniaturization of the hearing aid. The hearing aids can be readily lost, and the batteries may be difficult or impossible for some users to change. Further, some hearing aid users have to share a room with another hearing aid user, which raises problems associated with losing or confusing the devices in the room. Further, it may not be readily apparent if the battery of the device is no longer operational.

Known hearing aid systems include body-worn hearing aids, currently considered to be undesirable compared to miniaturized hearing aids due to the bulk and available sound quality.

As such, a need exists for a hearing aid device or system that is suitable for improving the operability for certain populations, particularly populations of hearing aid wearers needed help with their daily care. Not only certain hearing aid wearers, but also their caregivers can be regularly faced with problems, such as keeping track of the device, knowing if the batteries are functioning, handling the electrical connections between the devices and charging the devices despite the possibility of limited fine motor abilities, and other difficulties.

### SUMMARY

A body-worn hearing aid system is set forth. The system includes a body worn hearing aid device. The device is provided in a casing. The body-worn hearing aid device includes first and second microphones adapted to receive audio input signals. A first digital signal processor is provided. The first digital signal processor is adapted and constructed to receive an output from the first microphone and produce a first output signal according to a first unique hearing profile. A second digital signal processor is also provided. The second digital signal processor is adapted and constructed to receive the output from the second microphone and produce a second output signal according to a second unique hearing profile. A magnetic coupling charging element can be selectively and operatively connected to the casing of the body-worn hearing aid device.

A binaural hearing aid system for a user is also set forth. The system includes a casing adapted and constructed to encase a hearing aid system suitable for wearing below the neck of the user. A first digital signal processor, having an audio input from a first microphone of the hearing system, is also provided. The first digital signal processor produces a first audio output corresponding to a first hearing profile. A second digital signal processor having the audio input from the second microphone of the hearing system is also provided. The second digital signal processor produces a second audio output corresponding to a second hearing profile.

The method of processing audio input in a hearing aid system is also set forth. The method includes the following steps. First and second digital signal processors are provided in a casing having first and second microphone inputs. First and second unique audio outputs are then generated according to a hearing profile of the user with the first and second digital signal processors, respectively, wherein each output is individually programmed. The first and second unique audio outputs are transmitted to remote first and second sound delivering devices operatively connected to the first and second audio outputs.

### DESCRIPTION OF THE DRAWINGS

FIG. 1 illustrates a front perspective view of an exemplary embodiment of a body-worn hearing aid system.

FIG. 2 illustrates a front view of an exemplary embodiment of a body-worn hearing aid system.

FIG. 3 illustrates a back view of an exemplary embodiment of a body-worn hearing aid system.

FIG. 4 illustrates a side view of an exemplary embodiment of a body-worn hearing aid system.

FIG. 5 illustrates a top view of an exemplary embodiment of a body-worn hearing aid system.

FIG. 6 illustrates a bottom view of an exemplary embodiment of a body-worn hearing aid system.

FIG. 7 illustrates an exploded perspective view of an exemplary embodiment of a body-worn hearing aid system.

FIG. 8 illustrates a perspective view of an exemplary embodiment of a headset of the body-worn hearing aid system.

### DETAILED DESCRIPTION

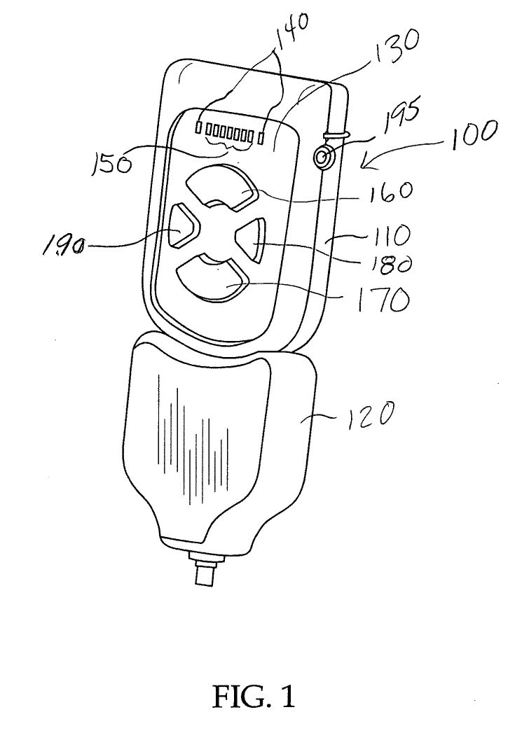

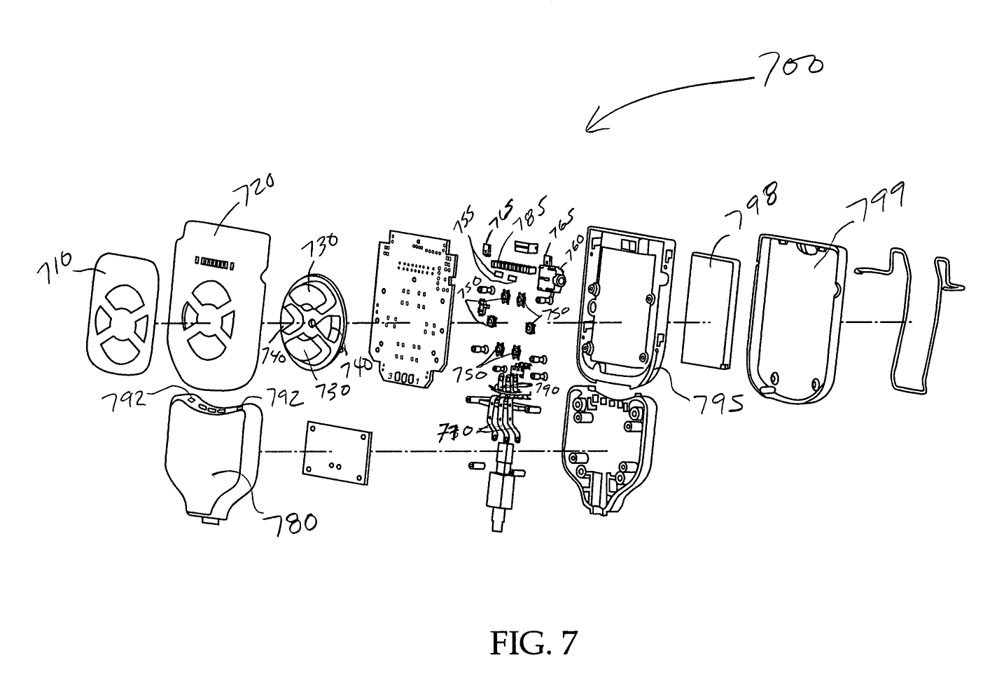

As illustrated in FIG. 1, an exemplary embodiment of a body-worn hearing aid system shown generally at 100 can include a casing 110 incorporating, for example, a binaural hearing aid device. The casing 110 can be selectively and operatively connected to a magnetic coupling charging element 120 via, for example, contact provided on an exterior of the casing 110 and an exterior of the magnetic coupling charging element 120, as shown in FIG. 7 below.

A front face 130 of the hearing aid device can include a light emitting diodes (LEDs) 140 for indicating an on/off/charging condition for the system. LEDs 150 are exemplary of a suitable external volume level reference for the system, although any external volume level reference for the system is contemplated herein. Further, suitable external volume controls, such as, for example, button 160 and button 170 can be provided. Additional buttons, such as buttons 180 and 190 can be provided for powering the system on and off, or for any other suitable purpose. An external connector port, such as a USB port or a connector for a jack, such as a connector 195 can be provided for connecting an audio delivery device to the body-worn hearing aid system 100.

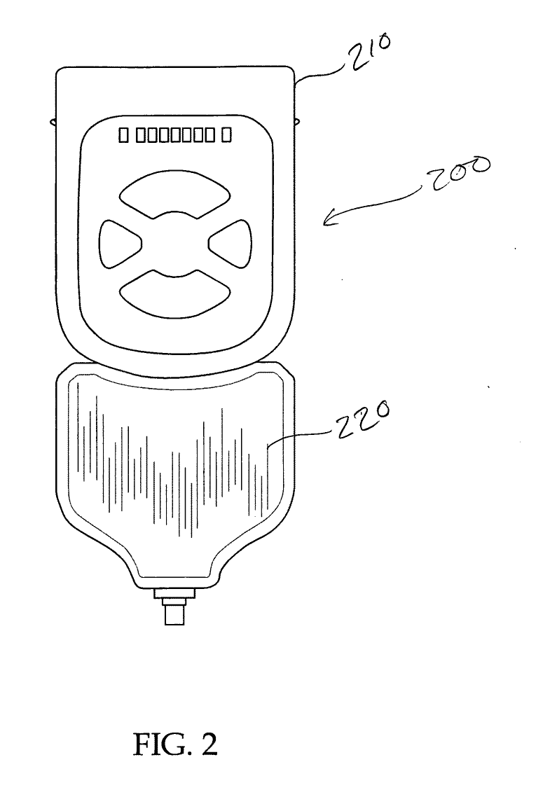

As illustrated in the exemplary embodiment 200 of FIG. 2, a magnetic coupling charging element 220 can be readily separated from a casing 210 of the hearing aid device. This feature helps ensure the safety of a user, such as a limited mobility user, who can fall asleep while wearing the device.

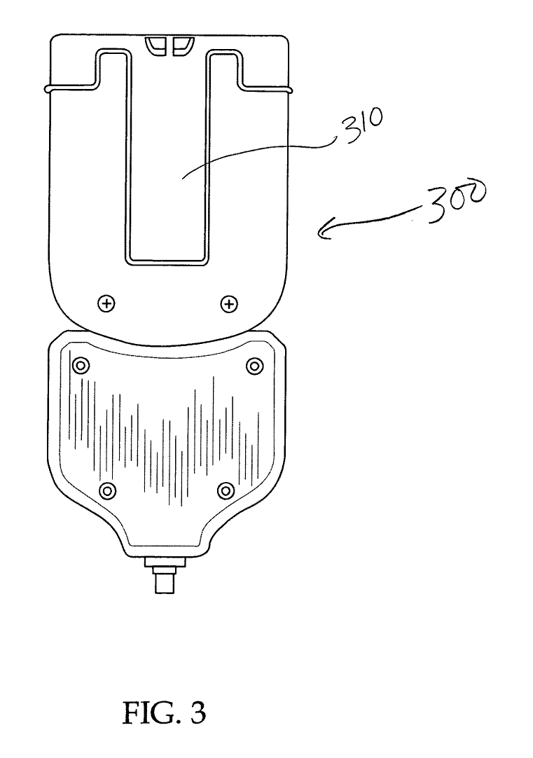

As illustrated in the exemplary embodiment 300 of FIG. 3, the hearing aid system can have, for example, an integrally formed clip 310 for securing the system 300 to a garment, sheet, or any other suitable anchoring device.

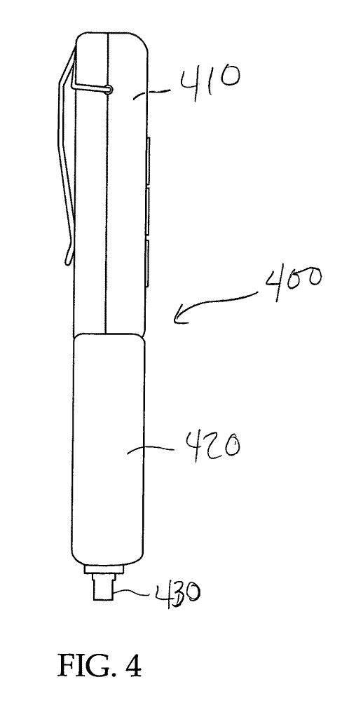

FIG. 4 illustrates a side view of a hearing aid system shown generally at 400. The size of the system 400 is compact, similar in size as a conventional cellphone, for example. A magnetic coupling charging element 420 is selectively connected to a casing 410 of the system 400. The magnetic coupling charging element 420 provides power to the system 400 via an ac connection to a cord 430.

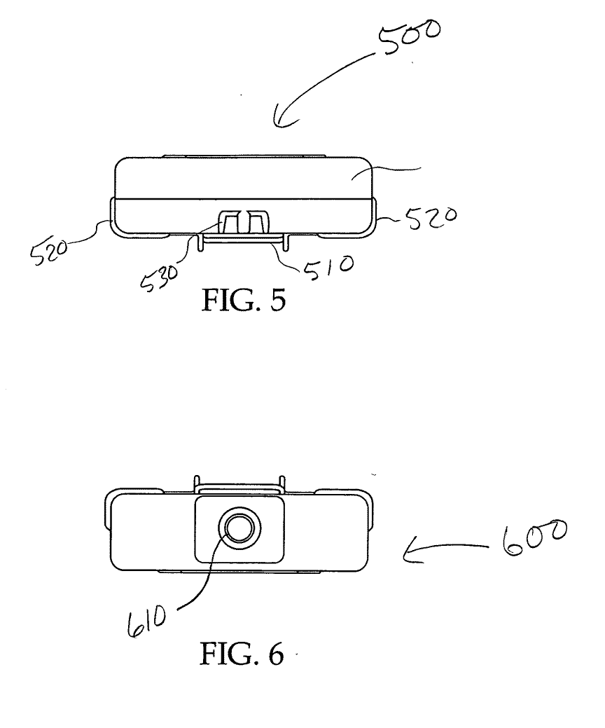

FIG. 5 illustrates a top view of an exemplary system 500, wherein a clip 510 is secured to the system 500 via sides 520 and top 530 of the system 500.

FIG. 6 illustrates a bottom of an exemplary system 600, wherein a cord 610 is provided for selectively connecting the system 600 to an AC power source.

An exploded view of an exemplary system 700 is illustrated in FIG. 7. A faceplate 710 is provided. The faceplate 710 connects to a frontplate 720 of the system 700. Buttons 730 or other selection devices can be provided for adjusting the volume of the system 700. Other suitable volume adjusting devices, such as a remote control or touchscreen, are contemplated as alternatives to the buttons described and shown herein. Further, power buttons 740 can be provided, or any other suitable device or screen for turning the device or its' components on/off. Switches 750 can be provided, for example, for operating various buttons, such as buttons 730 and 740 of the system. First and second digital processors 755 are provided, and are selected from commercially available digital signal processors. Alternatively, one or more of the digital signal processors 755 can incorporate a hearing test, as discussed in detail , for example, in U.S. Ser. No. 12/270,385, incorporated herein by reference above.

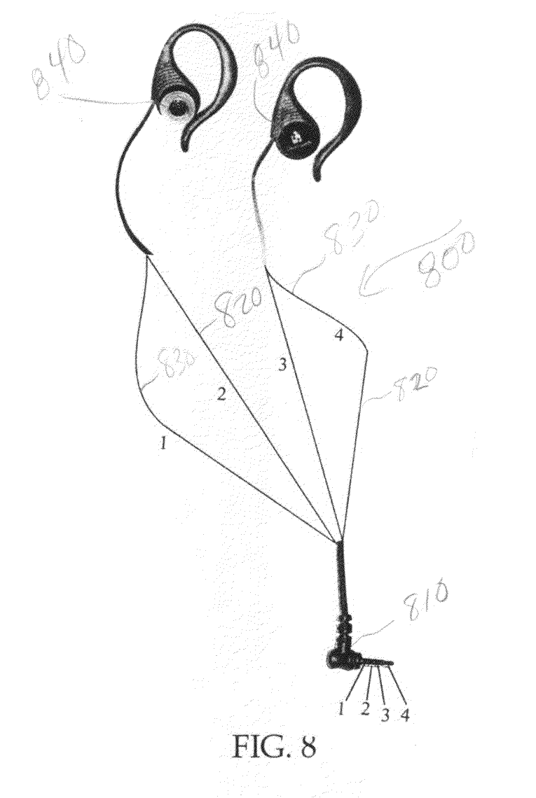

A jack 760 or USB port, or other suitable output device can be provided for connecting the system 700 to audio transmitting devices, such as a headset (illustrated in FIG. 8) or a wireless receiver, or any other suitable audio transmission device. First and second microphones 765 can be provided, and any suitable commercially available hearing aid microphone is contemplated herein. Metal contacts 770 of a magnetic coupling charging element 780 can be selectively connected via magnets 792 to metal contacts 790 of the hearing aid device casing 795. LEDs 785 can be selected from commercially available materials, or suitable alternatives, for indicating the power on/off and volume level of the system. The device can be suitable powered by a battery source, such as, for example, a cellphone battery 798 selectively connected to a backplate 799 of the system 700.

As illustrated in FIG. 8, a suitable audio delivery device, such as a headset shown generally at 800 can be provided for delivering audio output to an ear of a user. The headset 800 can include a connector, suitable chosen so as to stay connected to the device despite movement or rolling over of the user. First and second output signal leads 820 are provided for conveying the audio output signal from the the first and second digital signal processors, respectively. Additionally, first and second ground wires 830 are connected to the first and second digital signal processors, respectively. The grounds must be separately connected and cannot be shared by the digital signal processors for proper functioning of the device.

Further, although any suitable audio delivery device can be provided, unique, vented earbuds, 840, commercially available from Cotron, provide optimum sound delivery without blocking ambient sound. Alternatively, a wireless audio delivery device or other suitable device can be provided for delivering audio from the hearing aid system.

It is to be understood that embodiments of the present system and method may have a variety of different configurations and may be formed of a variety of materials. Depending on the application, there may be one or a plurality of structural elements. Also, the plurality of structural elements may be arranged in different configurations relative to one another depending on the application.

The present system and method are not limited to the particular details of the depicted embodiments and other modifications and applications are contemplated. Certain other changes may be made in the above-described embodiments without departing from the true spirit and scope of the present system and method herein involved. It is intended, therefore, that the subject matter of the above depiction shall be interpreted as illustrative and not in a limiting sense.

We claim:

1. A body-worn hearing aid system comprising:
a body worn hearing aid device provided in a casing, the body-worn hearing aid device including first and second microphones adapted to receive an audio input signal,
a first digital signal processor adapted and constructed to receive an output from the first microphone and produce a first output signal according to a first unique hearing profile, and
a second digital signal processor adapted and constructed to receive the output from the second microphone and produce a second output signal according to a second unique hearing profile; and
a magnetic coupling charging element selectively and operatively connected to the casing of the body-worn hearing aid device.

2. The system of claim 1, further comprising:
a hearing test system, operatively stored in the first and second digital signal processors, adapted and constructed to generate a plurality of tones to elicit responses from a user of the device, whereby the responses to the tones ascertain a hearing profile of the user provided in the first and second digital signal processors, and adapted and constructed to produce a custom hearing profile for the system.

3. The system of claim 1, further comprising a power indicating light, wherein the power indicating light illuminates when power is on for the first and second microphones.

4. The system of claim 1, further comprising a row of leds, wherein the leds are illuminated to indicate a volume level for the system, and wherein a selection button is provided on an exterior casing of the body-worn hearing aid system for selecting the volume level of the system.

5. The system of claim 4, wherein a button is provided on the exterior casing of the system for selectively switching the power to the first and second microphones.

6. The system of claim 1, further comprising a headset including a first signal lead and a first ground lead for the first output signal, and a second signal lead and a second ground lead for the second output signal.

7. The system of claim 6, further comprising earbuds connected to the first and second signal leads and first and second grounds, respectively, wherein the earbuds are adapted and constructed with a vent to deliver ambient sound to the ear.

8. The system of claim 1, further comprising a rechargeable battery operatively connected to the system.

9. The system of claim 1, wherein contacts are provided on a bottom of the casing of the body-worn hearing device for selectively electrically connecting the magnetic coupling charging element to the body-worn hearing device to form the body-worn hearing aid system.

10. A binaural hearing aid system for a user comprising:
a casing adapted and constructed to encase a hearing aid system suitable for wearing below the neck of the user;
a first digital signal processor having an audio input from a first microphone of the hearing system, the first digital signal processor producing a first audio output corresponding to a first hearing profile; and
a second digital signal processor having the audio input from a second microphone of the hearing system, the second digital signal processor producing a second audio output corresponding to a second hearing profile.

11. The system of claim 10, further comprising:
a hearing test system, operatively stored in the first and second digital signal processors, adapted and constructed to generate a plurality of tones to elicit responses from a user of the device, whereby the responses to the tones ascertain a hearing profile of the user provided in the first and second digital signal processors, and adapted and constructed to produce a custom hearing profile for the system.

12. The system of claim 10, further comprising a power indicator on an exterior of the casing.

13. The system of claim 10, a volume level indicator on an exterior of the casing.

14. The system of claim 10, further comprising a power switch on an exterior of the casing.

15. The system of claim 10, further comprising a first lead and a first ground operatively connected to the first audio output, and a second lead and a second ground operatively connected to the second audio output.

16. The system of claim 16, further comprising first and second headset earbuds operatively and respectively connected to the first lead and the first ground and the second lead and the second ground.

17. The system of claim 10, further comprising a sound delivering device adapted and constructed to deliver sound to the ear canal, operatively connected to the first and second audio outputs.

18. The method of processing audio input in a hearing aid system comprising the steps of:
providing first and second digital signal processors in a casing having first and second microphone input;
generating first and second unique audio outputs according to a hearing profile of the user with the first and second digital signal processors, respectively, wherein each output is individually programmed; and
transmitting the first and second unique audio outputs to remote first and second sound delivering devices operatively connected to the first and second audio outputs.

19. The method of claim 18, further comprising the step of: connecting a headset having a first lead and ground connected to the first unique audio output and a second lead and ground connected to the second unique audio output for transmitting the first and second unique audio outputs to the remote first and second sound delivery devices.

20. The method of claim 18 further comprising the step of:
selectively charging the hearing aid system with a magnetic coupling charging element selectively connected to the casing of the hearing aid system.
